(19) United States
(12) Patent Application Publication
(10) Pub. No.: US 2015/0117731 A1
(43) Pub. Date: Apr. 30, 2015

(54) Computational metric that forms a component of computer-aided detection systems for magnetic resonance imaging

(71) Applicant: Jacob Levman, Toronto (CA)

(72) Inventor: Jacob Levman, Toronto (CA)

(21) Appl. No.: 14/061,769

(22) Filed: Oct. 24, 2013

(51) Int. Cl. G06T 7/00

(52) U.S. Cl. CPC G06T 7/0012; G06T 2207/10088
USPC 382/131

(57) ABSTRACT

This document presents a computational metric which can form a component of a computer-aided detection algorithm applied to magnetic resonance imaging examinations.

### FIELD OF THE INVENTION

This invention is directed to computer-aided detection algorithms, an application of computer systems.

### BACKGROUND OF THE INVENTION

The methodology proposed in this patent is to be executed in a computer system with a communication link to a magnetic resonance imaging (MRI) machine. The method proposed is intended to provide an analytic computation that can be useful in computer-aided detection systems applied to magnetic resonance imaging. These types of computer algorithms are intended to assist in the imaging of diseases, ailments and abnormalities.

### BRIEF SUMMARY OF THE INVENTION

The following invention is a computation intended to produce a single measurement per pixel/voxel location on an MRI medical examination.

### BRIEF DESCRIPTION OF THE DRAWINGS

The invention is executed by computer. The invention will be better understood from a reading of the following detailed description in conjunction with the following drawings.

FIG. 1 shows the computation that is performed by computer on data acquired in an MRI examination.

### DETAILED DESCRIPTION OF THE INVENTION

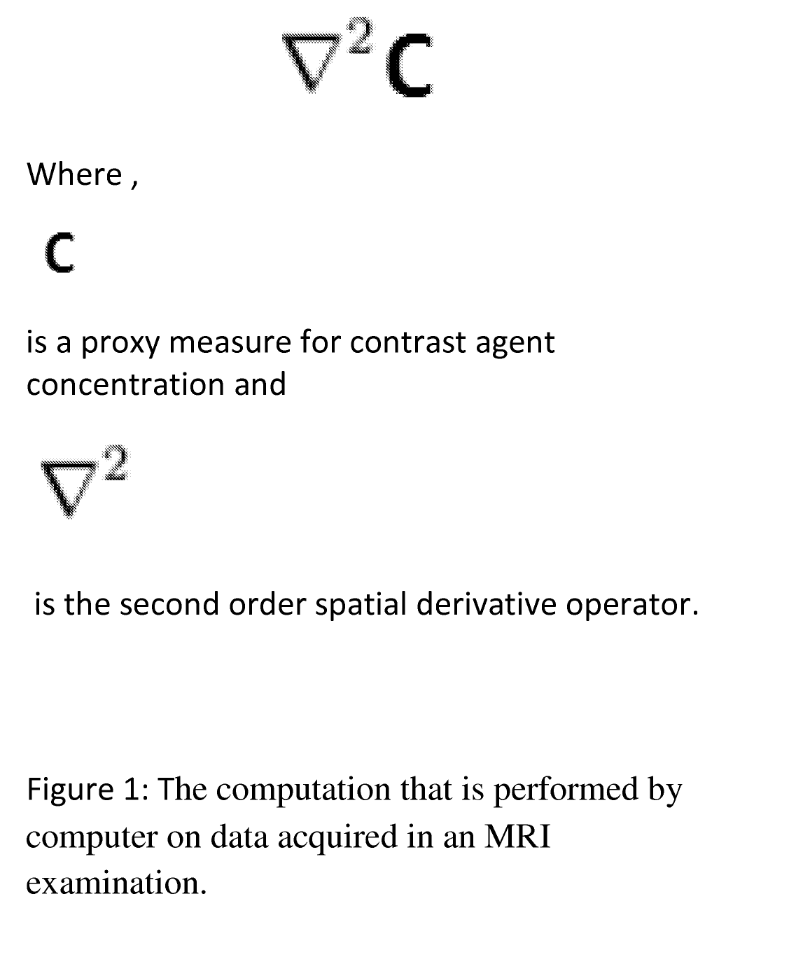

This invention embodies a data processing methodology to be executed by computer as defined in FIG. 1.

A proxy measure for contrast agent concentration is obtained via MRI and the second order spatial derivative of those measurements is computed.

In one example embodiment of the invention the technique is used as a component of a computer-aided detection system for breast cancer detection from MRI. The relative signal intensity as acquired at the first time point post injection of contrast agent (signal intensity at the bolus peak divided by the signal intensity before injection) was used as an example proxy measure for local contrast agent concentration. The computation is able to lower the false positive rate produced by the overall computer-aided detection system by forcing benign diagnoses on tissue samples whose evaluated computation from FIG. 1 is lower than a given threshold.

The invention claimed is:

1. A method for the processing of magnetic resonance imaging based medical examinations to generate a measurement that can be incorporated into a computer-aided detection system.
